(19) United States
(12) Patent Application Publication
(10) Pub. No.: US 2008/0172278 A1
(43) Pub. Date: Jul. 17, 2008

(54) Service management system

(75) Inventors: Michael W. Hanizeski, Greendale, WI (US); Thomas E. Lowery, Whitefish Bay, WI (US); David J. Writz, Mequon, WI (US); Patrick M. Foley, Olathe, KS (US); Scott A. Adams, Wales, WI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 11/652,239

(22) Filed: Jan. 11, 2007

(51) Int. Cl. G06F 17/30; G06Q 30/00

(52) U.S. Cl. 705/8; 705/7; 705/34

(57) ABSTRACT

A service management system includes a voice portal system configured to receive service description data from a service professional via voice recognition, and a service posting database system operatively connected to the voice portal system and configured to store the received service description data.

### FIELD

The present invention relates generally to the field of service management systems. The present invention relates more specifically to systems and methods for providing an integrated voice recognition and scheduling and dispatch system for service management.

### BACKGROUND

In general, a service management system is a system that supports service tasks throughout a service lifecycle for a business entity that conducts service tasks. A service lifecycle generally includes the identification of a customer issue that requires the attention of a service professional, scheduling a service visit, completing the service visit, and reporting the service visit. Service management systems of varying levels of sophistication provide varying levels of support throughout the service lifecycle. Service professionals, customer service agents, and customers typically interact with the service management system. A computerized service management system generally contains a database or databases, a customer service agent user interface, and a reporting module.

Customers typically interact with the service management system via the customer service agents. Customer service agents may create service records in a database and schedule service appointments. A service professional typically picks up a service schedule at the beginning of the day and begins making service visits. As the service professional completes work, he or she generally fills out a service description form, perhaps hands the customer a copy of the form, and travels to his or her next service location. At the end of the day or week, whenever the service professional next visits the service center, he or she typically turns in a collection of completed service description forms. A data entry person, sometimes a customer service agent, then updates relevant service database records. If the service has been completed, customer invoices are then created based on information in the database. Once customers have been invoiced, the service lifecycle is typically completed.

The service lifecycle will often have inefficiencies and challenges due to the unknown nature of the service visit. One significant challenge is scheduling. An individual service professional's schedule is typically set at the beginning of the service day. The service professional is given a list of appointments he is responsible for throughout the day. This appointment list is typically based upon static appointment times and the assigned geographic area of the service professional. For example, if a single service professional is assigned to a single geographic region, he or she is typically assigned a daily appointment calendar consisting of specific customer appointments at specific time windows in his specific geographic region. If a service appointment takes too long, or even if the service professional finishes an appointment early, scheduling problems develop. On one hand, service appointments for which the required time is underestimated may lead to late service professionals or rushed jobs. On the other hand, if service appointments end early, service resources may be wasted if a service professional is waiting for the next job. Additionally, while geographic assignments may appear to make sense at the beginning of the day, at any given point during the day a different service professional may be closer to a customer destination than the service professional originally planned.

Another challenge and inefficiency arises from the usual manual nature of the service professional reporting process. Once a service professional completes his or her task, he or she will typically fill out a manual report regarding the completed service visit. The service professional typically turns his or her collection of completed manual reports into the service center at the beginning of his next day, or whenever he or she next physically reports to the service center. These reports are then either manually entered or scanned into a computer system. The manual paper reports submitted by the service professional are typically prone to error. Short of losing the paper altogether, the service professional's handwriting or marks could be difficult to decipher, longhand descriptions often take valuable time to write, increase the delay between job completion and invoice, and require many human resource hours at the service center for data entry or data review and filing. Moreover, the comments to the customers may not be consistent and professional, and may just be shorthand written by the service technician upon completion of the job.

In addition to the basic reporting challenges and inefficiencies, lack of standardization in the reporting process presents challenges after data entry has occurred. For data to be most useful, it must be consistent, standardized, and granular. Service management systems typically do not have these attributes because of the manual and delayed nature of the typical reporting method. For example, for tracking purposes, it is desirable to categorize service visits and solutions for reporting purposes. However, if data regarding the service visit and solution is stored in a singular “description” field, rather than fragmented and stored as relevant information pieces, tracking and querying the data is much more difficult.

There is a need for a system wherein service professional scheduling is conducted on a dynamic basis throughout the service day. Further, there is a need for a more automated and standardized service reporting system and process. Further, there is a need for a service management system that may utilize voice recognition technology to facilitate the automated and standardized service reporting system and process. Further, there is a need for a service management system containing integrated systems driven by consistent, standardized, and granular data extracted from the service professional by voice recognition technology. Further, there is a need for standardized customer invoicing fed by the service data extracted. Moreover, there is a need for real-time schedule and route optimization of service professionals.

It would be desirable to provide a system and/or method that provides one or more of these or other advantageous features. Other features and advantages will be made apparent from the present specification. The teachings disclosed herein extend to those embodiments that fall within the scope of the appended claims, regardless of whether they accomplish one or more of the aforementioned needs.

### SUMMARY

According to an exemplary embodiment, a service management system includes a voice portal system configured to receive service description data from a service professional via voice recognition technology, and a service posting database system operatively connected to the voice portal system and configured to store the received service description data.

According to another exemplary embodiment, a service management system includes a first database containing potential service description entries, a voice portal system configured to allow a service professional to vocally specify service description entries after the service professional has completed a service task, and a second database coupled to the voice portal system and configured to store the service description entries specify by the service professional in a service description record.

According to another exemplary embodiment, a method of using a service management system including providing a voice portal system, providing a service posting database system communicably connected to the voice portal system, establishing a voice connection between the voice portal system and a service professional, receiving service description data from the service professional via the voice portal system, building a service description record in the service posting database system using the received service description data.

The invention is capable of other embodiments and of being practiced or being carried out in various ways. Alternative exemplary embodiments relate to other features and combinations of features as may be generally recited in the claims.

### BRIEF DESCRIPTION OF THE FIGURES

The invention will become more fully understood from the following detailed description, taken in conjunction with the accompanying figures, wherein like reference numerals refer to like elements, in which:

FIG. 1 is a perspective view of a service center and a remote service location, illustrating a service professional interacting with a service management system from a remote location via a voice connection, according to an exemplary embodiment;

FIG. 2 is a block diagram of an integrated service management system having a service professional in communication with a voice portal of the service management system, according to an exemplary embodiment;

FIG. 3 is a detailed block diagram of an integrated service management system having a service posting database system and a posting guide database system, according to an exemplary embodiment;

FIG. 4 is a detailed block diagram of an integrated service management system having a customer invoicing system, according to an exemplary embodiment;

FIG. 5 is a detailed block diagram of an integrated service management system having a variety of subsystems including a resource scheduling system, according to an exemplary embodiment;

FIG. 6 is a flow chart of a method of using an integrated service management system, according to an exemplary embodiment.

### DETAILED DESCRIPTION OF EXEMPLARY EMBODIMENTS

Before turning to the figures, which illustrate the exemplary embodiments in detail, it should be understood that the invention is not limited to the details or methodology set forth in the following description or illustrated in the figures. The invention is capable of other embodiments or being practiced or carried out in various ways. It should also be understood that the phraseology and terminology employed herein is for the purpose of description only and should not be regarded as limiting.

In general, according to an exemplary embodiment, the systems and methods described herein for providing a service management system include the use of a voice portal system having voice recognition technology and a service posting database system. Service professionals use voice recognition facilitated by the voice portal system to report status, labor, materials, expenses, and work done. Service description information provided to the system by the service professionals is stored in a service posting database system. The potential entries to the service professional are standardized via a service order posting guide and via voice prompts from the voice portal system to the service professional during reporting. Customer invoices, service order summaries, and reports are created based on the service description data contained in the service posting database system. The information contained in the service posting database is tracked over time for performance analysis purposes. Because of the streamlined and vocal nature of the reporting system, service order posting or reporting can be accomplished in the field as service professionals complete work tasks. Further, because of the “real-time” nature of the system, the work schedule may also be optimized in real-time and updated dispatches may be communicated throughout the day to service professionals. The system also allows voice triggered on-demand service order reports, customer invoices, and timesheets to be e-mailed or faxed. Using the service management system with voice recognition may provide consistent reporting of work performed, a catalog of historical system performance for both customer and business use, and for the elimination of manual posting activity. For these reasons, the use of the service management system may result in more timely and accurate information throughout the service cycle.

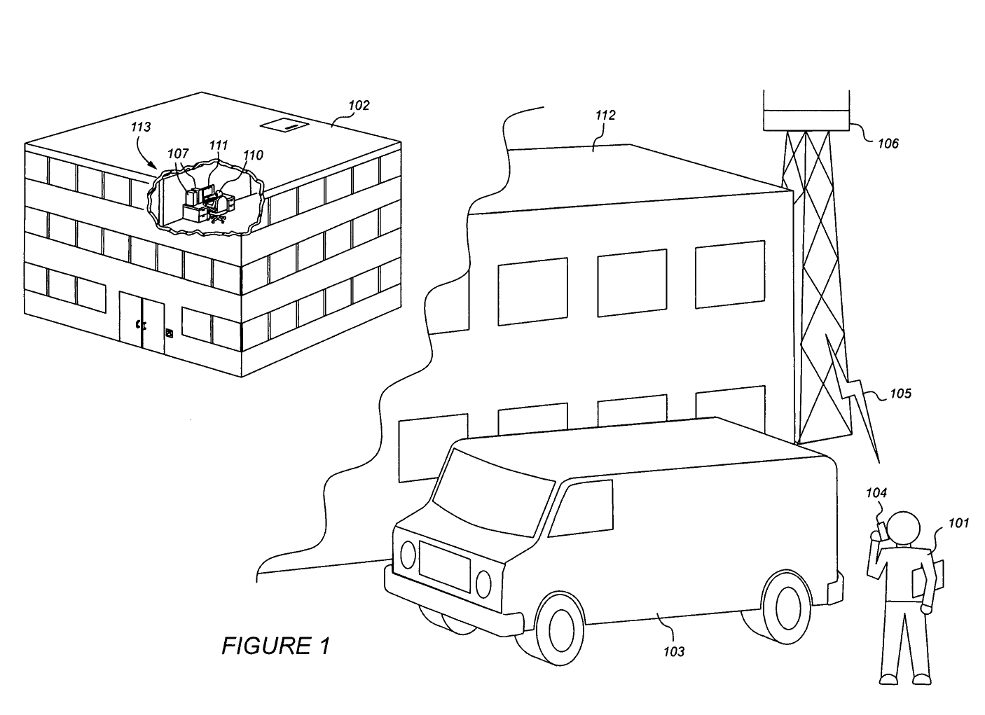

FIG. 1 is a perspective view of a service management system 107 interacting with a service professional 101 from a remote service location, according to an exemplary embodiment. Service professional 101 is shown in voice communication 105 with service management system 107 located within service management center 113. Service professional 101 is illustrated as having just exited a serviced building 112. Service professional 101 is reporting to the service management system 107 via voice communications device 104. Service operations agent 110 is shown interacting with a display 111 of service management system 107. When the service professional 101 has completed communication with the service management system 107, he or she may travel to the next remote service location or building via service vehicle 103.

According to an exemplary embodiment, service professional 101 is a service professional in any field where a service professional may complete service tasks and report service tasks (e.g., HVAC management, telecommunications, healthcare, electrical, plumbing, etc.). According to an exemplary embodiment, remote service location 100 may be any location (near or far from service management system 107) at which service tasks may be conducted by the service professional (e.g., remote office buildings, offices within one building or group of buildings, residential homes, hospitals, factories, boats, etc.).

Service management system 107, according to an exemplary embodiment, may include one or more computers, servers, or other pieces of electronic hardware or software as shown in FIG. 1. Service management system 107 may include one or more processing devices, memory devices, storage devices and any other hardware and/or software that may be used to implement the features of service management system 107. According to various other exemplary embodiments, service management system 107 may be considered to include all human actors (e.g., service agents 110, service professionals 101, etc.) and non-human components (e.g., wireless communications device 104, cellular tower 106, etc.) that may be used with or in service management system 107.

Voice communications device 104, as shown in FIG. 1, according to an exemplary embodiment, may be any type of voice communications device (e.g., wireless PDA, hardwired, satellite, cellular, WiFi, broadband, short range radio, etc.). According to an exemplary embodiment, voice communications device 104 may be of any design or technology of the past, present or future capable of facilitating voice communications between service professional 101 and service management system 107 (e.g., a cellular phone, etc.). According to an exemplary embodiment, voice communications device 104 is a cellular communications device having a cellular communication link 105 with cellular tower 106.

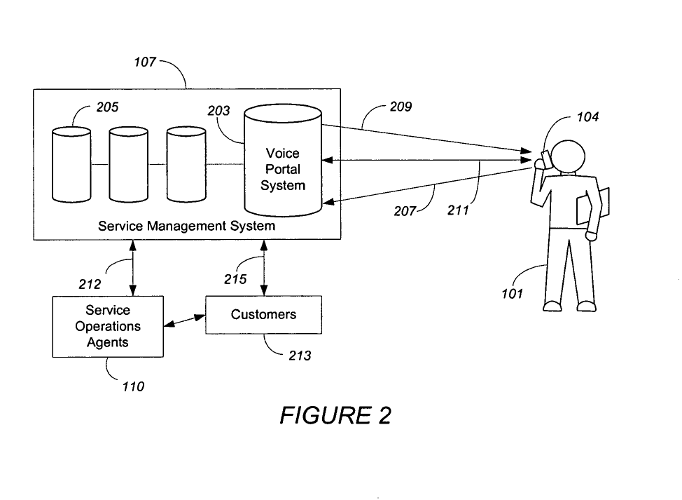

FIG. 2 is a block diagram of service management system 107, according to an exemplary embodiment, shown in communication with a service professional 101, customers 213, and service operations agents 110. Service professional 101 is illustrated as conducting voice communications with voice portal system 203. According to an exemplary embodiment, voice portal system 203 is a voice recognition system capable of conducting voice recognized communications. Voice portal system 203 may comprise any number of hardware and software subsystems. According to an exemplary embodiment, voice portal system 203 is implemented on a server having voice recognition software, communications hardware, processing hardware, audio output hardware and software, database software, data storage hardware, and one or more software systems managing or linking these hardware and software components. According to various alternative embodiments, voice portal system 203 may be implemented in a number of different ways. For example, voice portal system 203 may have any number of specialized voice recognition hardware parts. According to an exemplary embodiment, voice portal system 203 may be any voice communications system having voice recognition technology of the past, present or future. According to an exemplary embodiment, service management system 107 includes any number of other service management subsystems 205 that may be functionally or communicably coupled to voice portal system 203.

FIG. 2, according to an exemplary embodiment, displays the service management system 107 interacting with customers 213. Customers 213 may initiate communications with the service management system 107, or the customers 213 may be contacted by the service operations agents. For example, customers 213 may call service operations agents 110 when they are experiencing problems with serviceable equipment. These customers 213 may seek to schedule a service appointment if the problem cannot be resolved over the telephone. Service operations agents 110 may schedule customer-requested service appointments using the service management system 107. Service operations agents 110 may also call customers 213 to schedule planned service visits. Service operations agents 110 may generally interact with service management system 107 via a graphical user interface (e.g., that may be displayed on display 111 of FIG. 1, etc.) of service management system 107. Customers 213 may generally interact with service management system 107 by forming voice communications with service operations agents 110 (shown as communications link 212), but automated systems may be provided that allow customers 213 to interact directly with service management system 107 (shown as communications link 215).

As illustrated in FIG. 2, according to an exemplary embodiment, service professional 101 may send and receive a variety of different types of information to and from voice portal system 203 or service management system 107. Service professional 101 is shown as receiving voice prompts 209, sending and receiving optimized dispatch information 211, and sending and receiving status updates and service description data 207. According to various exemplary embodiments, service professional 101 may communicate in any number of ways with voice portal 203 or service management system 107. For example, a separate system (e.g., system 205, etc.) may send and receive optimized dispatch information. According an exemplary embodiment, communications 207, 209, 211 may be conducted during the same voice communications session and/or over the same voice communications connection. According to various other exemplary embodiments, communications 207, 209, 211 may use different communications sessions or connections. For example, voice prompts 209 and service description data 207 may be sent over a single cellular communications session while optimized dispatch information 211 may be received at data communications device located within the service vehicle 103.

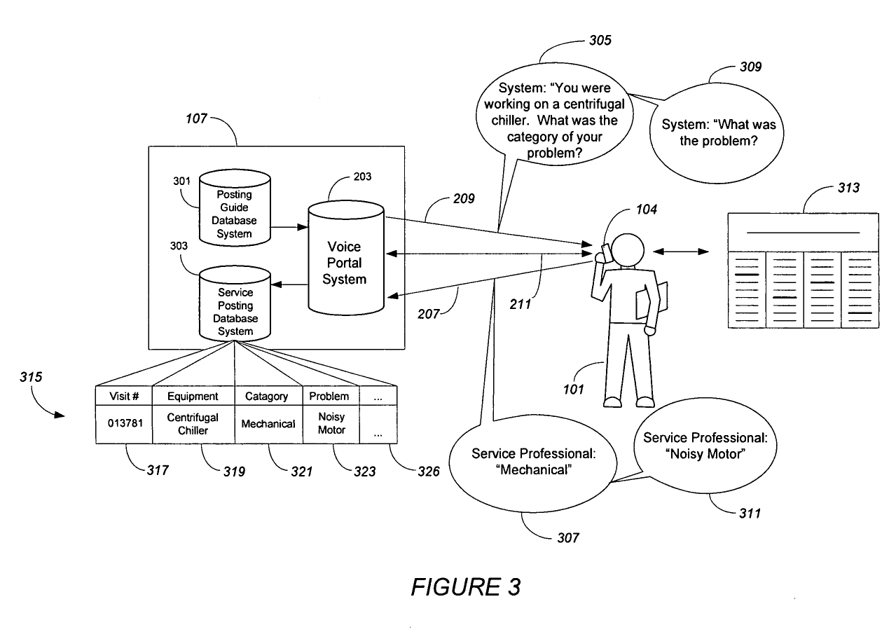

Referring to FIG. 3, according to an exemplary embodiment, any number of voice prompts 209 may be provided by voice portal system 203 to service professional 101. According to an exemplary embodiment, voice prompts 209 lead or drive communications between the service professional 101 and the service management system 107. When the service professional 101 completes a service job, for example, he or she may call into the service management system 107 and the voice portal 203. After the service professional 101 indicates that he has just completed a service appointment (e.g., via voice prompts, keypad commands, automatic determination, etc.), the voice portal system 203 may then begin prompting the service professional 101 for specific data related to the service appointment through a series of interview questions. When service professional 101 responds to the voice prompts 209 for service related data, the service professional 101 may respond with service description data 207. According to various alternative embodiments, service professional 101 may lead or drive the reporting communications (e.g., by providing service description data 207 in tagged data fragments, etc.).

According to an exemplary embodiment, both status updates and more specific service description data 207 may be stored in one or more subsystems of the service management system 107 during or after communications between the voice portal system 203 and the service professional 101. According to an exemplary embodiment, specific service description data 207 received from the service professional 101 is stored in service posting database system 303. Service posting database system 303 may be the primary data store of service management system 107, with its stored data potentially being used for a variety of scheduling and reporting purposes. Service posting database system 303 may include any number or type of database information structures (e.g., tables, relationships, designs, records, fields, lists, objects, properties, etc.). According to an exemplary embodiment, received service description data 207 creates or populates at least one service description record 315. As illustrated in FIG. 3, service description record 315 may include a number of fields related to the completed service visit. For example, service description record 315 may include a visit identifier 317, an equipment field 319, a category field 321, a problem field 323, and any number of subsequent fields 326. According to various alternative embodiments, service description record 315 may include any number of different fields relating to the varying industries or companies that may implement service management system 107. For example, in the context of healthcare, fields may include: appointment, patient, problem, category, diagnosis, etc. According to various alternative embodiments, a service description record 315 may be any type of record from a single record located within a single table to an overall record of a service visit spread across multiple databases, tables, relations, etc. According to an exemplary embodiment, service description record 315 and its related fields may be any data structure of the past, present or future capable of memorializing discrete service description data provided by service professionals.

Referring further to FIG. 3, according to an exemplary embodiment, a posting guide database system 301 may be coupled to the voice portal system 203. Posting guide database system 301 may be a database system containing many of the potential service description entries that may eventually populate the fields and records of service posting database system 303. For example, posting guide database system 301 may include a list of all equipment entries that could probably populate field 319. Posting guide database system 301 may also include similar lists of each potential category, problem, etc. These lists may be related such that once a piece of equipment has been identified, the posting guide database system 301 may select only related probable service categories and problems. Posting guide database system 301 may be designed to serve as a data source that may drive (e.g., assist in the creation of, etc.) the voice prompts 209 of voice portal system 203.

Referring further to FIG. 3, according to an exemplary embodiment, a series of possible voice prompts 305, 309 and accompanying service description data responses 307, 311 are illustrated. After a service professional 101 has established voice communications with voice portal system 203, the voice portal system 203 may prompt the service professional 101 with structured questions related to the service visit. For example, in prompt 305, the system may ask the service technician a question relating to the visit (e.g., “You were working on a centrifugal chiller. What was the category of your problem?,” etc.). The service professional 101 may then provide a response 307 (e.g., “mechanical,” etc.). As this process continues the voice prompts 209 may become a series of service visit interview questions 305, 309, etc. For example, the system may then ask “What was the problem?” The response to this question (e.g., “Noisy Motor,” etc.) may then be stored in the corresponding problem field 323. This interview process of voice prompts 209 will continue until the voice portal system has created a complete service description record 315 with populated service description fields (e.g., 317, 319, 321, 323, 326, etc.).

Referring further to FIG. 3, according to an exemplary embodiment, voice portal system 203 may use a posting guide database system 301 in any number of varying ways. For example, voice portal system 203 may attempt to match the responses (e.g., 307, 309, etc.) of the service professional with entries in the posting guide database system 301. When used in this manner, posting guide database system 301 may be used as a quality control mechanism (i.e., ensuring that service professional 101 is providing the right answer to a question or ensuring that service professional 101 is providing a response that may be accurately categorized within the system, etc.). According to various alternative embodiments, the voice portal system 203 may use the posting guide database system 301 to provide a menu of possible responses at each question level to the service professional 101 (if he or she so requires or requests). According to various alternative embodiments, the service professional 101 may also have access to a copy of the posting guide database system 301. In an exemplary embodiment shown in FIG. 3, service professional 101 may visually consult a hardcopy 313 of posting guide database system 301. According to other various embodiments, a copy of posting guide database system 301 may be located on a service professional's PDA, cell phone, or other device capable of user display or consultation. Hardcopy 313 may include a different page for each piece of equipment followed by various rows or columns listing the potential entries. According to various alternative embodiments, posting guide database system 301 may not be used with the service management system. According to various other exemplary embodiments, posting guide database system 301 may be integral with voice portal system 203, service posting database system 303, and/or any other system or subsystem of service management system 107. For example, posting guide database system 107 may exist as one or more tables within service posting database system 303 that are checked by software for consistency with received service description data 207. According to an exemplary embodiment, posting guide database system 301 is any system, design or components of the past, present or future capable of assisting service management system 107 with one or more data integrity or consistency tasks.

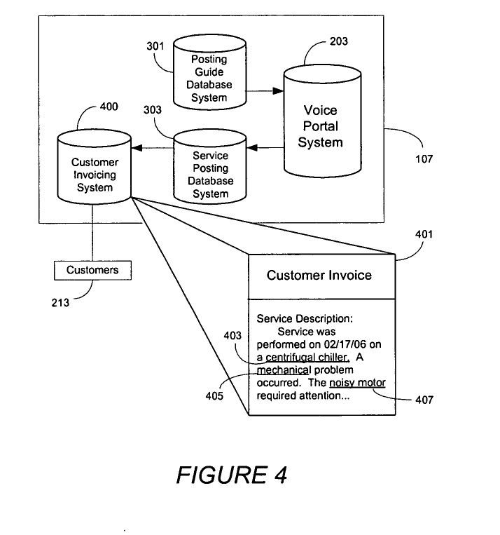

Referring to FIG. 4, according to an exemplary embodiment, one primary use for service posting database system 303 and its data is illustrated. FIG. 4 shows customer invoicing system 400 coupled in communication with service posting database system 303 and the rest of the service management system 107. Customer invoicing system 400 may communicate directly with customers (e.g., customer invoicing system 400 may send electronic invoices to customers 213, etc.). According to an exemplary embodiment, customer invoicing system 400 is capable of any number of invoicing or reporting functions, including the creation of customer invoices 401. According to an exemplary embodiment, customer invoices 401 may be created within the customer invoicing system 400 immediately after service professional 101 has completed his service description communications with the voice portal 203. This, advantageously, may help provide bills to customers 213 faster, help recover billed amounts faster, and/or may help eliminate time consuming manual data entry and checking tasks.

Referring further to FIG. 4, according to an exemplary embodiment, customer invoice 401 includes a service description narrative having a template with receiving fields 403, 405, 407 configured to receive the information stored in the service description records 315 and service description fields (317, 319, etc.). For example, as illustrated, the service description narrative may include one or more sentences having fields matching fields of the service description record 315. The information from the service description record 315 may be selected and inserted directly into the service description template fields of the service description template with minimal human intervention. For example, the service description narrative on the customer invoice 401 may include a field for equipment 403, a field for category 405, a field for problem 407, etc. The service description template may include pre-selected complete sentences such that service descriptions are professional and complete once populated. For example, the fragmented service description answers given by the service professional 101 are turned into professional customer invoice narratives without the service professional 101 having to manually write complete sentences while rushing to the next job. Example sentences are provides in FIG. 4. For example: “Service was performed on Feb. 17, 2006 on a [—equipment field—]” may become “Service was performed on Feb. 17, 2006 on a centrifugal chiller” when the service description narrative of the customer invoice has been populated.

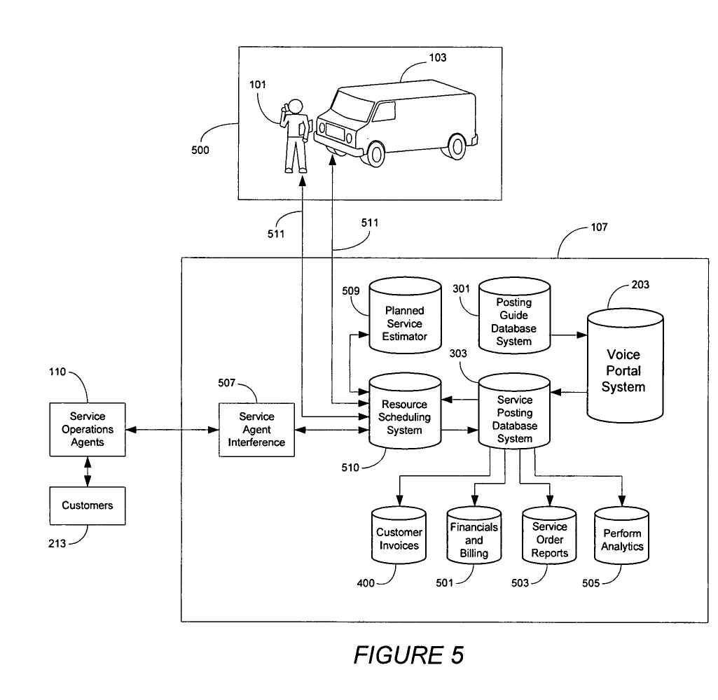

Referring to FIG. 5, according to an exemplary embodiment, a more detailed block diagram of service management system 107 is shown after the service professional has completed reporting to the voice portal system 203. Service management system 107 is shown in communication with service professional 101 and/or service vehicle 103. Service professional 101 is shown reporting from a remote location 500 (which may include serviced building 112 or communication tower 106) after he has completed reporting to the voice portal system 203. At this point, service professional 101 may be ready to receive his next service task. This task may come from a resource scheduling system 510. Resource scheduling system 510 may be coupled in communication with a planned service estimator 509, service posting database system 303, service agent interface 507, service professional 101, and/or service vehicle 103. Upon completing an assignment and reporting to the voice portal system, updated status information may be communicated from service posting database system 303 to resource scheduling system 510. Resource scheduling system 510 may be configured to optimize the schedules and/or other resources (e.g., labor or materials, etc.) of the service management system 107. For example, once a service professional 101 has completed a job, he may be assigned to the next scheduled service appointment based on a number of variables that may be derived from information the service professional 101 communicated to the voice portal system 203 and/or service posting database system 303. These variables may include location, materials used to complete the previous service visits, materials left on the service vehicle, whether the service professional is willing to continue working for the day, etc. According to an exemplary embodiment, resource scheduling system 510 may be any hardware and/or software of the past, present or future capable of using the status updates of the voice portal 203 or the service description data of the service posting database system 303 to set, edit, or optimize schedules of service professionals.

Referring to FIG. 5, according to an exemplary embodiment, service appointments are scheduled in at least two ways. First, the planned service estimator 509 may be a system capable of scheduling regular service visits based on any number of variables. Second, service appointments may be scheduled or entered to the resource scheduling system 510 via a service agent interface 507. According to various exemplary embodiments, resource scheduling system 510 may accept any number of other scheduling inputs, including, for example, inputs from the service professional 101 (e.g., the service professional 101 may recognize that follow-up service work is needed, etc.).

Referring further to FIG. 5, according to an exemplary embodiment, planned service estimator 509 may estimate when regular service visits should be scheduled based on variables such as the equipment type in use at customer locations, days of use, type of use, past service, recommended check-up periods, etc. According to various exemplary embodiments, planned service estimator 509 may be a separate hardware or software component residing within service management system 107 or be a hardware or software component integral with resource scheduling system 510. According to various exemplary embodiments, planned service estimator 509 may be any hardware or software of the past, present or future capable of providing a service estimating function to the resource scheduling system 510.

Referring further to FIG. 5, according to an exemplary embodiment, a service agent interface 507 is provided to service operations agents 110. Service operations agents 110 may generally receive service calls from customers 213, call customers to provide scheduling updates, and provide scheduling inputs to the resource scheduling system 510 (e.g., via service agent interface 507, etc.). The service agent interface 507 may allow the service operations agents to accomplish these tasks. Service operations agents 110 may also use the service agent interface 507 to communicate with service professionals 101, view status information within any of the other subsystems of service management system 107, and/or provide a measure of quality control to the automated or optimized scheduling features of resource scheduling system 510. For example, with service professional 101 having completed a service task, he may be ready to be assigned another service task. The resource scheduling system 510 may automatically assign service professional 101 to the next scheduled appointment within the general geographic region of the service professional's last visit. The service agent interface 507 would be able to communicate this automated selection and accompanying dispatch information to the service operations agent 110. The service operations agent 110, however, may first check to confirm that the automated selection is, in fact, the best course of action. The service operations agent 110 may be able to identify factors not included in the optimization function of the resource scheduling system 510 and may reject the automated scheduling selection and manually set portions of the service schedule. A service operations agent 110 may choose to manually set the schedule for any number of reasons, including, for example, customer preference, traffic, etc.

Referring further to FIG. 5, according to an exemplary embodiment, service agent interface 507 and resource scheduling system 510 may include GPS information and any number of maps or views to assist in scheduling and/or navigating the service professional 101 to the next service location. According to an exemplary embodiment, service vehicle 103 may include a GPS device configured to forward GPS information to resource scheduling system 510 on regular intervals. Resource scheduling system 510 may then make scheduling suggestions or decisions based on the received GPS information. According to an exemplary embodiment, resource scheduling system 510 or service agent interface 507 may use the received GPS information combined with service address information from the service management system 107 to map routes for service professionals 101. GPS information and route information may be forwarded to service professional 101 via communication links 511. Communication links 511 may include text messaging links, instant messaging links, voice links, cellular data links, etc. According to an exemplary embodiment, service professional 101 and/or service vehicle 103 have a display capable of receiving bitmaps of map information and routes. Map and route review may be another function of service operations agents 110 and service agent interface 507. According to an exemplary embodiment, service agent interface 507 is any hardware or software (off the shelf application or otherwise) of the past, present, or future capable of providing an interface of the service management system 107 to service operations agents 110.

Referring further to FIG. 5, according to an exemplary embodiment, a variety of subsystems are illustrated coupled in communication with service posting database system 303. These subsystems may include customer invoicing system 400, financials and billing systems 501, service order reports 503, and performance analytics 505. According to various exemplary embodiments, any number of additional systems may be included that may benefit from the advantages of the present invention. According to various exemplary embodiments, subsystems 400, 501, 503, 505, and any other subsystems may be coupled to different components of service management system 107 or may exist external to service management system 107. According to an exemplary embodiment, the system may also allow voice triggered, on-demand reports to be generated from any of the illustrated subsystems and others not shown (e.g., employee timesheets, etc.) and to be e-mailed, mailed, and/or faxed to various departments, employees, customers, etc.

Referring further to FIG. 5, according to an exemplary embodiment, financials and billing subsystems 501 may advantageously obtain more consistent and information rich data from the service management system 107 compared to conventional systems. Additionally, financials and billing subsystems 501 may run in “real time” or close-in-time to the completion of service tasks. For example, rather than waiting for manual data entry to occur in the days after a service task and/or more extensive human checking, voice portal system 203 and service posting database system 303 may access completed records of a service visit data immediately after service professionals 101 have completed voice reporting. Additionally, because the data has been normalized (e.g., the service data has been broken into separate or atomic fields, etc.) information rich queries may be conducted of the service description data. This may, advantageously, allow the financials and billing subsystem 501 to more accurately bill customers for labor and materials actually used on the job. For example, in a conventional system the service professional may simply write a service description and may check some materials-used checkboxes. However, because of the voice prompt driven and vocal description retrieval process of service management system 107, each aspect of the service visit has likely been consistently and immediately memorialized within service posting database system 303. According to an exemplary embodiment, financials and billing subsystem 501 may not exist at all or may exist in any number of forms.

Referring further to FIG. 5, according to an exemplary embodiment, a service order reporting subsystem 503 may exist within service management system 107. Service order reporting subsystem 503 may also leverage the granular or atomic nature of the data within service posting database system 303 to provide highly accurate service reporting functions soon after a service professional has completed a service task. The reports of service order reporting subsystem 503 may include any number of reports (e.g., service professional efficiency, resource utilization, materials used, materials wasted, percentage of time spent on certain problems, travel time, etc.). According to an exemplary embodiment, service order reporting subsystem 503 may not exist at all or may exist in any number of forms capable of providing additional reporting features to the service management system 107.

Referring further to FIG. 5, according to an exemplary embodiment, a performance analytics subsystem 505 may exist within service management system 107. Performance analytics subsystem 505 may provide additional “high level” or “business level” analysis and reports based on the service data. Performance analytics subsystem 505 may be additionally coupled to any of the other subsystems of the service management system 107 (e.g., performance analytics subsystem 505 may be coupled to the billing and service order reports subsystems, etc.). Performance analytics subsystem 505 may provide detailed statistics regarding failure rates of specific pieces of equipment, return service rates, bills recovered for varying service visits, etc. Performance analytics subsystem 505 may advantageously use the information rich data of service management system 107 to create business decision assisting reports that may previously have only been created through great effort. According to an exemplary embodiment, performance analytics subsystem 505 may not exist within service management system 107 or may be any system capable of providing additional querying or reporting functions to the service management system 107.

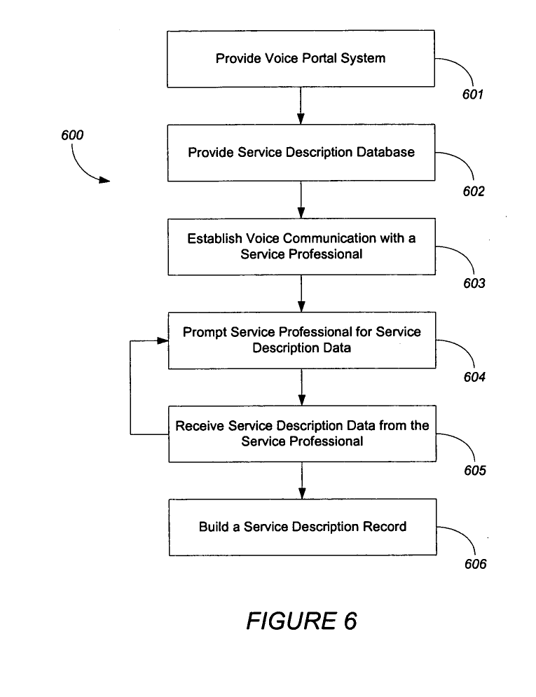

Referring further to FIG. 6, according to an exemplary embodiment, a process 600 is provided for using a service management system using voice recognition technology. According to an exemplary embodiment, a voice portal system may be provided (step 601). A voice portal system may be a voice portal system or voice recognition system as described above or otherwise, and capable of providing voice prompts and receiving vocal service description data from remotely located service professionals. A voice portal system may include voice recognition technology and may be coupled to any number of subsystems. According to an exemplary embodiment, a service posting database system is provided (step 602). The service posting database may be a service posting database system as described above or otherwise, and capable of providing a service data storage function to the service management system. According to an exemplary embodiment, after a voice portal and a service posting database system have been provided, a voice communication connection between the voice portal and the service professional may be established (step 603). The voice communications connection may be of any type as described above or otherwise. Once a voice communications connection has been established, the voice portal system may begin prompting the service professional for service description data (step 604). As the service professional hears the prompts, he may speak into his voice communications device. At the voice portal, service description data from the service professional may be received (step 605). Service description data may be received in a single word, multiple word, fragmented, granular, atomic, complete sentence format, and/or any other form. According to various alternative embodiments, service description data may be received by asking or prompting the service professional 101 with yes/no questions and/or other decision assisting questions. Prompting (step 604) and receiving (step 605) may continue until a complete service description record has been built (step 606). According to an exemplary embodiment, service description fields of service description records within the service posting database system are populated as data is received from the service professional. According to various alternative embodiments, the service data is stored in a temporary record and inserted into a service description record within the service posting database system when a complete temporary record has been built. According to various alternative exemplary embodiments, additional steps may be provided to process 600. Similarly, some steps of process 600 may be skipped and/or changed in order.

While the exemplary embodiments illustrated in the figures and described above are presently preferred, it should be understood that these embodiments are offered by way of example only. Accordingly, the present invention is not limited to a particular embodiment, but extends to various modifications that nevertheless fall within the scope of the appended claims. The order or sequence of any processes or method steps may be varied or re-sequenced according to alternative embodiments.

Describing the invention with figures should not be construed as imposing on the invention any limitations that may be present in the figures. The present invention contemplates methods, systems and program products on any machine-readable media for accomplishing its operations. The embodiments of the present invention may be implemented using an existing computer processors, or by a special purpose computer processor for an appropriate vehicle system, incorporated for this or another purpose or by a hardwired system.

It is important to note that the construction and arrangement of the service management system as shown in the various exemplary embodiments is illustrative only. Although only a few embodiments of the present inventions have been described in detail in this disclosure, those skilled in the art who review this disclosure will readily appreciate that many modifications are possible without materially departing from the novel teachings and advantages of the subject matter recited in the claims. For example, elements shown as integrally formed may be constructed of multiple parts or elements (e.g., voice portal system, service posting database system), the position of elements may be reversed or otherwise varied (e.g., the elements of FIGS. 1-6), and the nature or number of discrete elements or positions may be altered or varied (e.g., customer invoicing system, customer invoice, service description record, service description template, service description template field, etc.). Accordingly, all such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present inventions as expressed in the appended claims.

As noted above, embodiments within the scope of the present invention include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions. It should be noted that although the diagrams herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software implementations of the present invention could be accomplished with standard programming techniques with rule based logic and other logic to accomplish the various connection steps, processing steps, comparison steps and decision steps.

What is claimed is:

1. A service management system, comprising:
a voice portal system configured to receive service description data from a service professional via voice recognition technology; and
a service posting database system operatively connected to the voice portal system and configured to store the received service description data.

2. The system of claim 1, further comprising:
a customer invoicing system capable of providing customer invoices that may be sent to customers, wherein the customer invoicing system uses a service description template containing at least one data field configured to display the received service description data.

3. The system of claim 2, wherein the service description template contains a service description narrative having a plurality of data fields configured to display the received service description data.

4. The system of claim 3, wherein the voice portal system is configured to prompt the service professional with a series of interview questions, and wherein the service professional provides service description data to the voice portal systems as answers to the interview questions;
and wherein the answers to the interview questions are used to populate fields in the service posting database system.

5. The system of claim 1, further comprising:
a scheduling system communicably connected to the service posting database system;
wherein the scheduling system is configured to update a work schedule based on the service description data received from the service professional.

6. The system of claim 5, wherein the scheduling system is further configured to optimize the work schedules of a plurality of service professionals using the service description data received from the service professional.

7. The apparatus of claim 6, further comprising:
a service agent user interface communicably connected to the scheduling system and configured to display the optimized schedules of service professionals.

8. The apparatus of claim 7, wherein the scheduling system is further configured to calculate optimized travel routes and wherein the service agent user interface is further configured to display the optimized travel routes.

9. A service management system, comprising:
a first database containing potential service description entries;
a voice portal system configured to allow a service professional to vocally specify service description entries after the service professional has completed a service task; and
a second database coupled to the voice portal system and configured to store the service description entries specified by the service professional in a service description record.

10. The system of claim 9, wherein the system further comprises a service analysis guide located with the service professional, the service analysis guide containing at least a subset of potential service description entries.

11. The system of claim 9, wherein the voice portal system is configured to assist the service professional in the selection of service analysis entries by prompting the service professional with a series of interview questions.

12. The system of claim 9, wherein the system further comprises a third database located with the service professional, the third database containing potential service description entries, wherein the service professional may visually consult the third database from a remote service location.

13. The system of claim 12, wherein the third database is a printed service analysis guide.

14. The system of claim 9, wherein the system further comprises a schedule optimization system coupled to the voice portal system, the schedule optimization system being configured to optimize a work schedule of the service professional.

15. The system of claim 9, wherein the system further comprises a customer invoicing system having a plurality of customer invoicing fields, the customer invoicing system being coupled to the second database, wherein the service description entries specified by the service professionals and stored in a service description record are used to populate a plurality of customer invoicing fields.

16. A method of using a service management system, comprising:
providing a voice portal system;
providing a service posting database system communicably connected to the voice portal system;
establishing a voice connection between the voice portal system and a service professional;
receiving service description data from the service professional via the voice portal system;
building a service description record in the service posting database system using the received service description data.

17. The method of claim 16, wherein the service description data is a series of service description fragments.

18. The method of claim 17, wherein each service description fragment becomes a field in the service description record.

19. The method of claim 17, including the step of prompting the service professional with a series of automated interview questions related to the service description data and designed to extract standardized responses from the service professionals.

20. The method of claim 19, wherein the series of automated interview questions are based on a service order posting guide and its contents.

21. The method of claim 18, further comprising:
providing a service description template containing at least one service description template field configured to receive a service description fragment;
populating the service description template field with service description fragments from a corresponding field of a service description record.

22. The method of claim 21, wherein a set of service description template fields are provided and populated.

23. The method of claim 22, wherein the set of populated service description template fields may create a work narrative for inclusion on a customer invoice.

24. The method of claim 16, further comprising:
communicating service description data to a scheduling system.

25. The method of claim 24, wherein the scheduling system is configured to store schedules of at least one service professional and a plurality of service appointment schedules.

26. The method of claim 25, further including:
optimizing the schedules of the scheduling system using the service description data received from the service professional.

27. The method of claim 16, further comprising:
creating reports based on the records of the service posting database system.
